(19) United States
(12) Patent Application Publication
(10) Pub. No.: US 2004/0098268 A1
(43) Pub. Date: May 20, 2004

(54) MPEG audio encoding method and apparatus

(75) Inventor: Ho-Jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/702,737

(22) Filed: Nov. 7, 2003

Related U.S. Application Data
(60) Provisional application No. 60/424,344, filed on Nov. 7, 2002.

(30) Foreign Application Priority Data
Jan. 21, 2003 (KR) 2003-4097

(51) Int. Cl. G10L 19/00

(52) U.S. Cl. 704/500

(57) ABSTRACT

An MPEG audio encoding method, a method for determining a window type when encoding MPEG audio, a psychoacoustic modeling method when encoding MPEG audio, an MPEG audio encoding apparatus, an apparatus for determining a window type when encoding MPEG audio, and a psychoacoustic modeling apparatus in an MPEG audio encoding system are provided. The MPEG audio encoding method comprises performing modified discrete cosine transform (MDCT) on an input audio signal in a time domain; with the MDCT performed MDCT coefficients as an input, performing psychoacoustic model; and by using the result of performing the psychoacoustic model, performing quantization, and packing a bitstream. According to the method, complexity of computation can be reduced and waste of bits can be prevented.

This application is based on and claims priority from provisional application serial No. 60/424,344, filed Nov. 7, 2002, and Korean Patent Application No. 03-4097, filed Jan. 21, 2003, the contents of both applications are incorporated herein by reference in their entirety.

### BACKGROUND OF THE INVENTION

1. Field of the Invention

The present invention relates to compression of digital audio data, and more particularly, to a moving picture experts group (MPEG) audio encoding method and an MPEG audio encoding apparatus.

2. Description of the Related Art

MPEG audio is a standard method for high quality, high efficiency stereo encoding of the International Organization for Standardization/International Electrotechnical Commission (ISO/IEC). That is, in parallel with moving picture encoding, MPEG audio was standardized in the MPEG of ISO/IEC Subcommittee 29/working group 11 (SC 29/WG11). When compression, sub-band coding (band division encoding) based on 32 frequency bands and modified discrete cosine transform (MDCT) are used, and by using a psychoacoustic characteristic, high efficiency compression is achieved. With this new technology, MPEG audio can realize higher sound quality than the prior art compression coding methods.

MPEG audio uses a perceptual coding method in which in order to compress an audio signal with high efficiency, the encoding amount is reduced by omitting detailed information having a lower sensitivity with using a sensory characteristic of a human being.

In addition, the perceptual coding method using the psychoacoustic characteristic in MPEG audio uses the minimum audible limit and masking characteristic in a silent environment. The minimum audible limit in a silent environment is a minimum level of sound that can be heard by human ears, and relates to the limit of noise in a silent environment that can be heard by human ears. The minimum audible limit in a silent environment varies with respect to the frequency of sound. In a certain frequency, a sound larger than the minimum audible limit in a silent environment can be heard, but a sound smaller than that cannot be heard. In addition, the audible limit of a predetermined sound greatly varies by another sound that is heard together, which is referred to as a ‘masking effect’. The frequency width where the masking effect occurs is referred to as a ‘critical band’. In order to efficiently use the acoustic psychology such as this critical band, it is important to first divide a signal by frequency, for which the frequency band is divided into 32 bands and sub-band encoding is performed. Also, at this time, a filter referred to as a ‘poly-phase filter bank’ is used to remove aliasing noise of the 32 bands in the MPEG audio.

Thus, MPEG audio comprises bit allocation using the filter bank and psychoacoustic model, and quantization. By using psychoacoustic model 2, MDCT coefficients generated as a result of performing MDCT are compressed with allocating optimum quantization bits. In order to allocate optimum bits, psychoacoustic model 2 is based on fast Fourier transform (FFT), and calculates masking effects by using a spreading function such that a large amount of computational complexity is required.

FIG. 1 is a flowchart showing a conventional encoding process in MPEG-1 layer 3.

First, if input PCM signals of 1152 samples are received in step 110, these signals pass a filter bank and noise in the signals is removed in step 120. Then, the signals are input to MDCT step.

Also, with receiving these input signals, psychoacoustic model 2 is performed in step 130, in which a signal to noise ratio (SNR) is calculated in step 140, pre-echo removal is performed in step 150, and a signal to masking ratio (SMR) for each sub-band is calculated in step 160.

By using thus calculated SMR value, MDCT is performed for the signals, which passed the filter bank, in step 170.

Then, quantization for MDCT coefficients is performed in step 180, and by using the quantized result, MPEG-1 layer 3 bitstream packing is performed in step 190.

A specific process of a psychoacoustic model 2 shown in FIG. 1 is shown in FIG. 2.

First, if 576 sample signals from the input buffer are received, an SNR is calculated.

First, FFT for the received signals is performed in step 141. For the magnitude of FFT result r(w), energy eb(b) and unpredictability Cw are calculated according to the following equations 1 and 2 in step 142:

eb(b)=Σr(w)² (1)

$${C}_{w} = \frac{\begin{matrix}( ( ( r ( w ) cos ( f ( w ) - rp ( w ) {cos ( fp ( w ) )}^{2} + \\ ( ( r ( w ) {sin ( f ( w ) - rp ( w ) {sin ( fp ( w ) )}^{2} )}^{0.5}\end{matrix}}{r ( w ) + abs ( rp ( w )} \qquad ( 2 )$$

Here, r(w) denotes the magnitude of FFT, f(w) denotes the phase of FFT, rp(w) denotes a predicted magnitude, and fp(w) denotes a predicted phase.

Then, energy e(b) and unpredictability c(b) of each band are calculated according to the following equations 3 and 4 in step 143:

$$\begin{matrix}e ( b ) = {\sum }_{bandlow}^{bandhigh} {r ( w )}^{2} & ( 3 ) \\ C ( b ) = {\sum }_{bandlow}^{bandhigh} {r ( w )}^{2} \times {C}_{w} & ( 4 )\end{matrix}$$

Next, by using a spreading function, energy ec(b) and unpredictability threshold ct(b) of each band are calculated according to the following equations 5 and 6 in step 144:

$$\begin{matrix}e c ( b ) = {\sum }_{bandlow}^{bandhigh} e ( b ) * {spreading}_{func .} & ( 5 ) \\ c t ( b ) = {\sum }_{bandlow}^{bandhigh} c ( b ) * {spreading}_{func .} & ( 6 )\end{matrix}$$

Then, a tonality index is calculated according to the following equation 7:

$$t b ( b ) = - 0.2999 - 0.43 ( \frac{c t ( b )}{e c ( b )} ) \qquad ( 7 )$$

Next, an SNR is calculated according to the following equation in step 145:

SNR=max(min val, tb(b)*TMN+(1−tb(b)NMT) (8)

Here, minval denotes a minimum SNR value in each band, TNM denotes tonal masking noise, NMT denotes nose masking tone, and SNR denotes a signal to noise ratio.

Next, perceptual energy is calculated in step 146.

Then, it is determined whether or not the calculated perceptual entropy exceeds a predetermined threshold in step 151.

If the result of determination indicates that the perceptual entropy exceeds the predetermined threshold, it is determined that the input 576 sample signal block is a short block in step 153, and if the perceptual entropy does not exceed the predetermined threshold, it is determined that the input 576 sample signal block is a long block in step 152.

Next, when it is determined that the input block is a long block, ratio_l is calculated for each of 63 bands as the following:

ratio_{—}l=ct(b)/eb(b)

Then, when it is determined that the input block is a short block, each of 43 bands is divided into three parts and ratio_s is calculated as the following:

ratio_{—}s=ct(b)/eb(b)

The conventional encoding process as described above performs FFT for input samples, calculates energy and unpredictability in a frequency domain, and applies the spreading function to each band such that a huge amount of computation is required.

The psychoacoustic model enables audio signal compression by using the characteristic of the human ear, and plays a key role in audio compression. However, implementing the model needs a huge amount of computation. In particular, calculation of the psychoacoustic model using FFT, unpredictability, and the spreading function requires a huge amount of computation.

FIG. 3A is a graph showing the result of FFT calculation in MPEG-1 layer 3, and FIG. 3B is a graph showing the result of performing long-window MDCT in MPEG-1 layer 3.

Referring to FIGS. 3A and 3B, though the FFT result and the MDCT result are different to each other, the prior art applies the result calculated in the FFT domain to the MDCT such that it causes waste of bits.

### SUMMARY OF THE INVENTION

The present invention provides an MPEG audio encoding method, a method for determining a window type when encoding MPEG audio, a psychoacoustic modeling method when encoding MPEG audio, an MPEG audio encoding apparatus, an apparatus for determining a window type when encoding MPEG audio, and a psychoacoustic modeling apparatus in an MPEG audio encoding system by which the complexity of computation can be reduced and waste of bits can be prevented.

According to an aspect of the present invention, there is provided a moving picture experts group (MPEG) audio encoding method comprising: (a) performing modified discrete cosine transform (MDCT) on an input audio signal in a time domain; (b) with the MDCT performed MDCT coefficients as an input, performing psychoacoustic model; and (c) by using the result of performing the psychoacoustic model, performing quantization, and packing a bitstream.

According to another aspect of the present invention, there is provided an MPEG audio encoding method comprising: (a) by using the energy difference of signals in a frame and the energy difference of signals of different frames, determining a window type of the frame for an input audio signal in a time domain; (b) with considering a pre-masking parameter that is a representative value for forward masking, and a post-masking parameter that is a representative value for backward masking, performing a parameter-based psychoacoustic model for MDCT coefficients that are obtained by performing MDCT for an input audio signal in a time domain; and (c) by using the result of performing the psychoacoustic model, performing quantization, and packing a bitstream.

According to still another aspect of the present invention, there is provided a window type determination method when encoding MPEG audio, comprising: (a) receiving an input audio signal in a time domain, and converting into an absolute value; (b) dividing the signals converted into absolute values into a predetermined number of bands, and calculating a band sum that is the sum of signals belonging to a band, for each band; (c) performing first window type determination by using the band sum difference between bands; (d) calculating a frame sum that is the sum of entire signals converted into the absolute values, and by using the difference between a previous frame sum and a current frame sum, performing second window type determination; and (e) by combining the result of performing the first window type determination and the result of performing the second window type determination, determining a window type.

According to yet still another aspect of the present invention, there is provided a parameter-based psychoacoustic modeling method when encoding MPEG audio, comprising: (a) receiving MDCT coefficients obtained by performing MDCT for an input audio signal, and converting into absolute values; (b) calculating a main masking parameter by using the converted absolute value signal; (c) calculating the magnitude of each signal for each band by using the converted absolute value signal, and calculating the magnitude of main masking by using the converted absolute value signal and the main masking parameter; (d) calculating the magnitude of a band by applying a pre-masking parameter that is a representative value for forward masking and a post-masking parameter that is a representative value for backward masking, to the magnitude of each band, and calculating a main masking threshold by applying the pre-masking parameter and post-masking parameter to the magnitude of main masking; and (e) calculating the ratio of the calculated magnitude of each band to the calculated main masking threshold.

According to a further aspect of the present invention, there is provided an MPEG audio encoding apparatus comprising an MDCT unit which performs MDCT on an input audio signal in a time domain; a psychoacoustic model performing unit which performs psychoacoustic model with the MDCT performed MDCT coefficients as an input; a quantization unit which by using the result of performing the psychoacoustic model, performs quantization; and a packing unit which packs the quantization result of the quantization unit into a bitstream.

According to an additional aspect of the present invention, there is provided an MPEG audio encoding apparatus comprising a window type determination unit which determines a window type of the frame for an input audio signal in a time domain, by using the energy difference of signals in a frame and the energy difference of signals of different frames; a psychoacoustic model performing unit which with considering a pre-masking parameter that is a representative value for forward masking, and a post-masking parameter that is a representative value for backward masking, performs a parameter-based psychoacoustic model for MDCT coefficients that are obtained by performing MDCT for an input audio signal in a time domain; a quantization unit which performs quantization, by using the result of performing the psychoacoustic model; and a packing unit which packs the quantization result of the quantization unit into a bitstream.

According to an additional aspect of the present invention, there is provided a window type determination apparatus when encoding MPEG audio, comprising an absolute value conversion unit which receives an input audio signal in a time domain, and converts into an absolute value; a band sum calculation unit which divides the signals converted into absolute values into a predetermined number of bands, and calculates a band sum that is the sum of signals belonging to a band, for each band; a first window type determination unit which performs first window type determination by using the band sum difference between bands; a second window type determination unit which calculates a frame sum that is the sum of entire signals converted into the absolute values, and by using the difference between a previous frame sum and a current frame sum, performs second window type determination; and a multiplication unit which by combining the result of performing the first window type determination and the result of performing the second window type determination, determines a window type.

According to an additional aspect of the present invention, there is provided a psychoacoustic modeling apparatus in an MPEG audio encoding system, the apparatus comprising an absolute value conversion unit which receives MDCT coefficients obtained by performing MDCT for an input audio signal, and converts into absolute values; a main masking calculation unit which calculates a main masking parameter by using the converted absolute value signal; an e(b) and c(b) calculation unit which calculates the magnitude of each signal for each band by using the converted absolute value signal, and calculates the magnitude of main masking by using the converted absolute value signal and the main masking parameter; an ec(b) and ct(b) calculation unit which calculates the magnitude of a band by applying a pre-masking parameter that is a representative value for forward masking and a post-masking parameter that is a representative value for backward masking, to the magnitude of each band, and calculates a main masking threshold by applying the pre-masking parameter and post-masking parameter to the magnitude of main masking; and a ratio calculation unit which calculates the ratio of the calculated magnitude of each band to the calculated main masking threshold.

In order to reduce waste of bits and the amount of computation when encoding MPEG audio, what the present invention aims at is not to use the calculation result of a psychoacoustic model in an FFT domain for MDCT, but to apply a psychoacoustic model by using MDCT coefficients. By doing so, the waste of bits which occurs due to discrepancy between the FFT domain and the MDCT domain can be reduced, and complexity can be reduced by simplifying the spreading function into two parameters, post-masking and pre-masking parameters, while the same performance can be maintained.

### BRIEF DESCRIPTION OF THE DRAWINGS

The above objects and advantages of the present invention will become more apparent by describing in detail preferred embodiments thereof with reference to the attached drawings in which:

FIG. 1 is a flowchart showing a conventional encoding process in MPEG-1 layer 3;

FIG. 2 is a flowchart showing a specific process of a psychoacoustic model 2 shown in FIG. 1;

FIG. 3A is a graph showing the result of FFT calculation in MPEG-1 layer 3;

FIG. 3B is a graph showing the result of performing long-window MDCT in MPEG-1 layer 3;

FIG. 4 is a flowchart showing an example of an encoding process in MPEG-1 layer 3 according to the present invention;

FIG. 5 is a diagram showing the structure of signals input in an encoding process according to the present invention;

FIG. 6 is a detailed flowchart of a process determining a window type shown in FIG. 4;

FIG. 7A is a diagram showing the structure of an original signal used in determining a window type;

FIG. 7B is a diagram showing band values obtained by adding values in each band of the original signal shown in FIG. 7A;

FIG. 7C is a diagram showing values obtained by adding band values shown in FIG. 7B in each frame;

FIG. 8 is a detailed flowchart of MDCT and a parameter-based psychoacoustic model process shown in FIG. 4;

FIG. 9A is a diagram showing the structure of MDCT coefficient values used in a process performing a psychoacoustic model;

FIG. 9B is a diagram showing the result of converting the values shown in FIG. 9A into absolute values;

FIG. 9C is a diagram for explaining pre-masking and post-masking applied to each band;

FIG. 10 is a block diagram showing a detailed structure of a window type determination unit performing window type determination shown in FIG. 6;

FIG. 11 is a block diagram showing a detailed structure of a signal preprocessing unit shown in FIG. 10;

FIG. 12 is a diagram showing a detailed structure of psychoacoustic model performing unit which performs MDCT and a parameter-based psychoacoustic model process shown in FIG. 8;

FIG. 13 is a diagram showing the structure of a signal preprocessing unit shown in FIG. 12;

FIG. 14A is a short window masking table in a pre-masking/post-masking table shown in FIG. 12; and

FIG. 14B is a long window masking table in a pre-masking/post-masking table shown in FIG. 13.

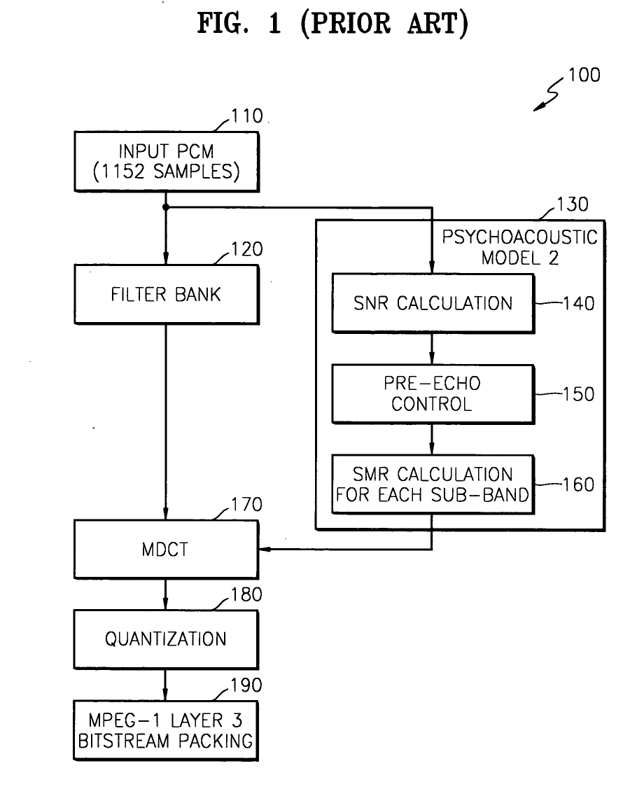

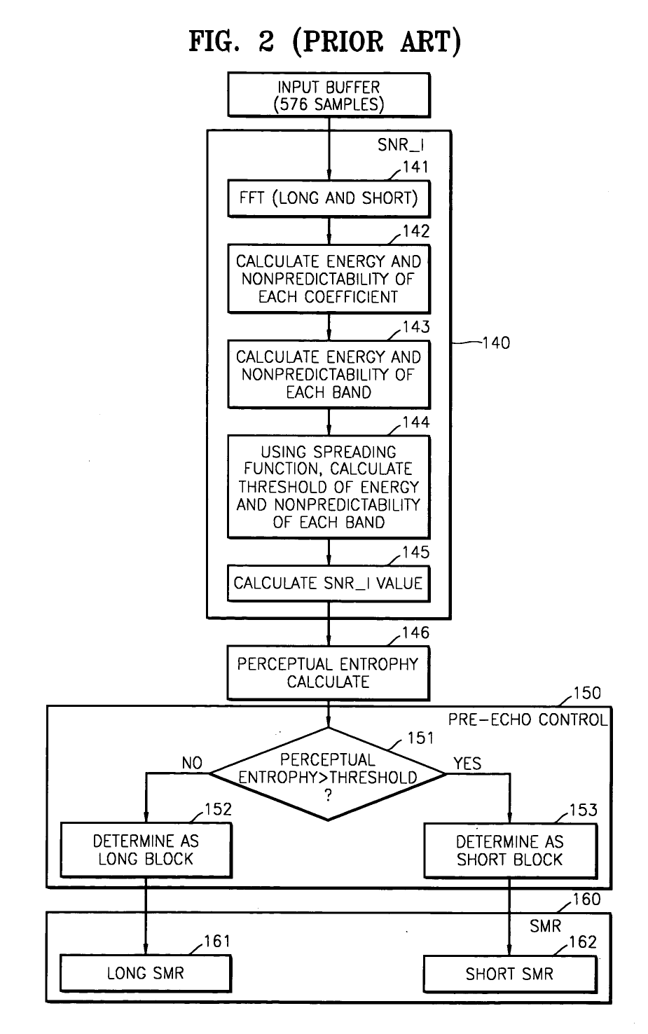

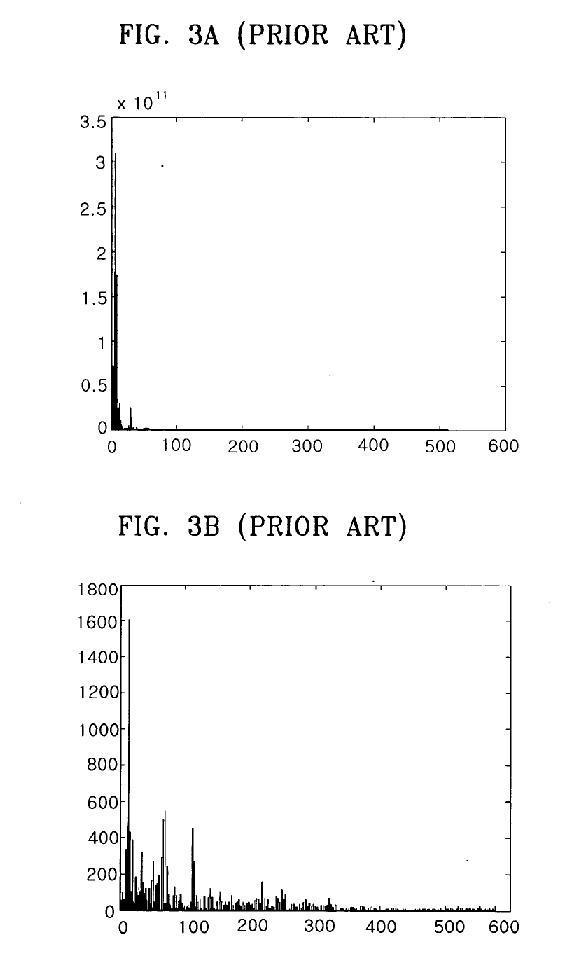

### DESCRIPTION OF THE PREFERRED EMBODIMENTS

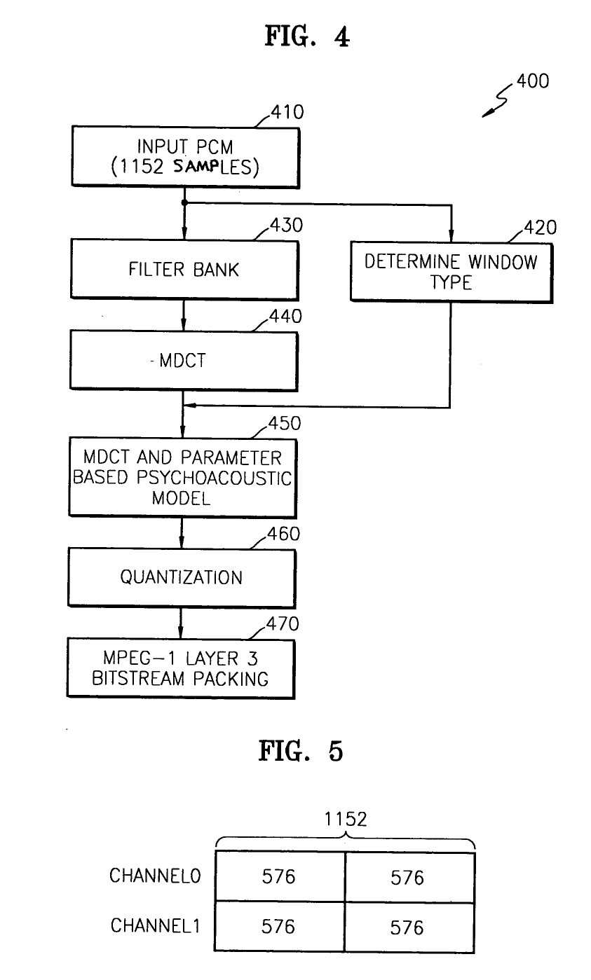

FIG. 4 is a flowchart showing an example of an encoding process 400 in MPEG-1 layer 3 according to the present invention.

First, an input PCM signal comprising 1152 samples is received in step 410.

The structure of an input signal used in MPEG encoding is shown in FIG. 5. The input signal comprises two channels, channel 0 and channel 1, and each channel comprises 1152 samples. A unit which is processed when encoding is actually performed is one that is referred to as a granule and comprises 576 samples. Hereinafter, the unit of an input signal comprising 576 samples will be referred to as a frame.

Next, a window type of a frame is determined for each frame of a received original signal in step 420. Unlike the prior art which determines the window type by using the result of performing FFT on the original signal, the present invention determines the window type for the original signal in the time domain. Through determining the window type by using the original signal without performing FFT, the present invention can greatly reduce the amount of computation compared to the prior art.

In addition, the received original signal is sent through a filter bank to remove noise in the signal in step 430, and MDCT is performed for the signal which is passed out of the filter bank in step 440.

Then, according to the MDCT performed MDCT coefficients and the result of the determination of a window type, a parameter-based psychoacoustic model process is performed in step 450. Unlike the conventional encoding process in which MDCT is performed for data obtained by performing a psychoacoustic model 2, in the present invention, MDCT is performed first and then, a modified psychoacoustic model is performed for the converted MDCT coefficient values. As described above, since there is discrepancy between the FFT result and the MDCT result, in the present invention the FFT result is not used and a psychoacoustic model is applied to the MDCT result such that encoding can be performed more completely without waste of bits.

Next, by using the result of performing the psychoacoustic model, quantization is performed in step 460, and MPEG-1 layer 3 bitstream packing is performed for the quantized values in step 470.

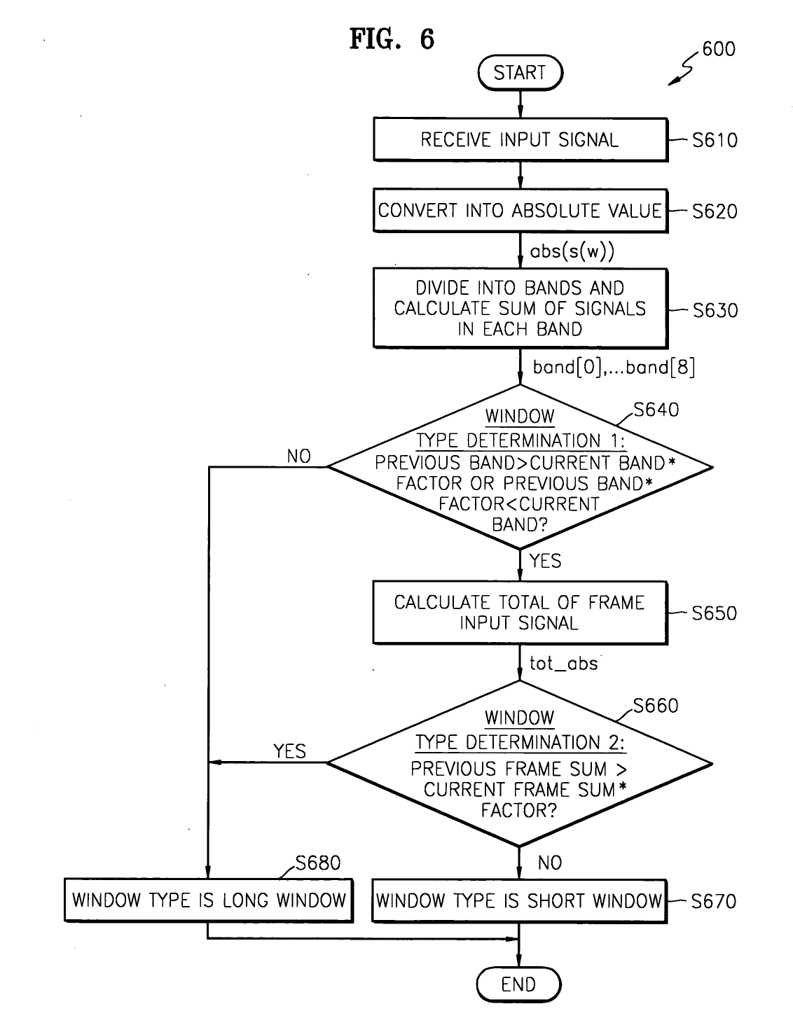

FIG. 6 is a detailed flowchart of a process determining a window type shown in FIG. 4.

First, if the original input signal is received in step S610, each original signal is converted into an absolute value in step S620.

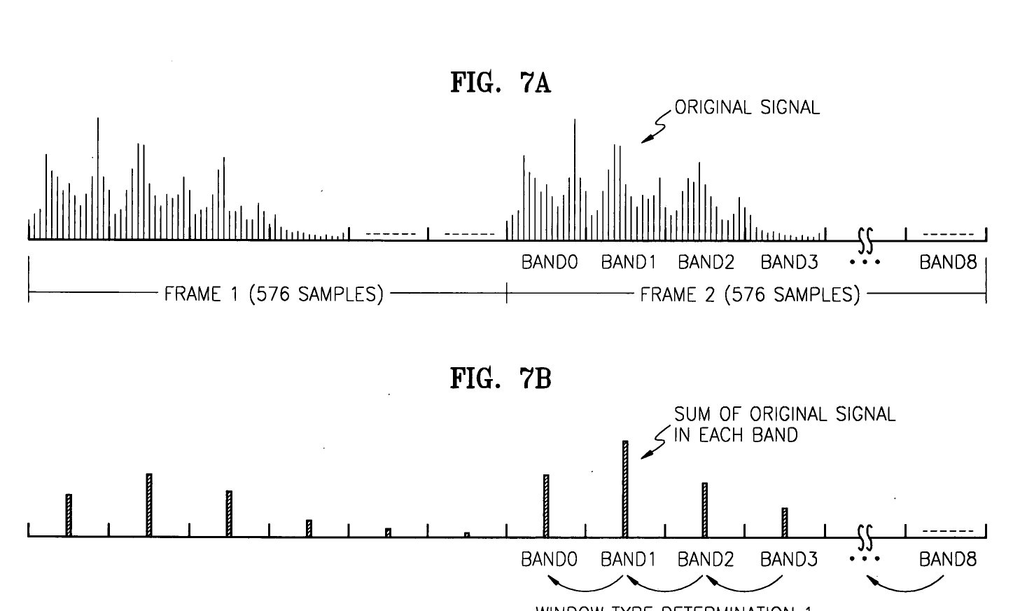

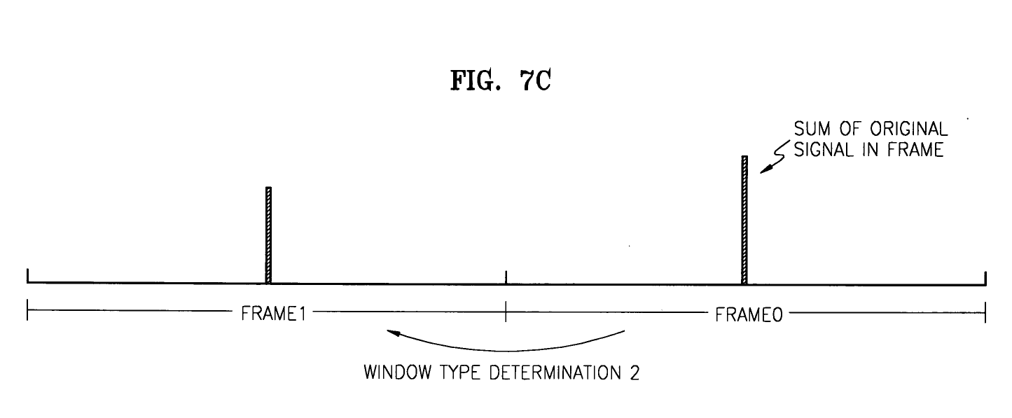

The original signal converted into an absolute value is shown in FIG. 7A. In FIG. 7A, two frames are shown and each frame comprises 576 samples.

Then, the signals arranged according to time are divided into bands, and the sum of signals in each band is calculated in step 630.

For example, as shown in FIG. 7A, one frame is divided into 9 bands, and as shown in FIG. 7B, signals in each band is summed up.

Next, by using the band signal, window type determination 1 is performed in step S640.

It is determined whether (a previous band>a current band * factor) or (a current band>a previous band * factor). This is to determine a window type for each band in a frame. If the difference between the summed signal values of the bands is big, the type is determined as a short window type, and if the difference is not big, the type is determined as a long window type.

If the result of the determination does not satisfy the condition, the window type is determined as a long window in step S680, and if the result of the determination satisfies the condition, the total of the frame input signal is calculated in step S650. For example, as shown in FIG. 7C, by adding band values in one frame, a frame sum signal is calculated.

Next, by using the frame sum signal, window type determination 2 is performed in step S660.

That is, it is determined whether or not (a previous frame sum>a current frame sum * 0.5). This is to determine a window type in units of frames, and to determine a window type as a long window type if the difference between frame sums is big even though the difference between the summed signal values of the bands is big.

If the result of determination satisfies the condition, the window type is determined as a long window and if the result does not satisfy the condition, the window type is determined as a short window in step S670.

If the window type is determined by the method described above, the window type can be determined with a higher precision, because the degree of changes in the magnitude of a signal in a frame is first considered, and the degree of changes in the magnitude of the signal between frames is considered next.

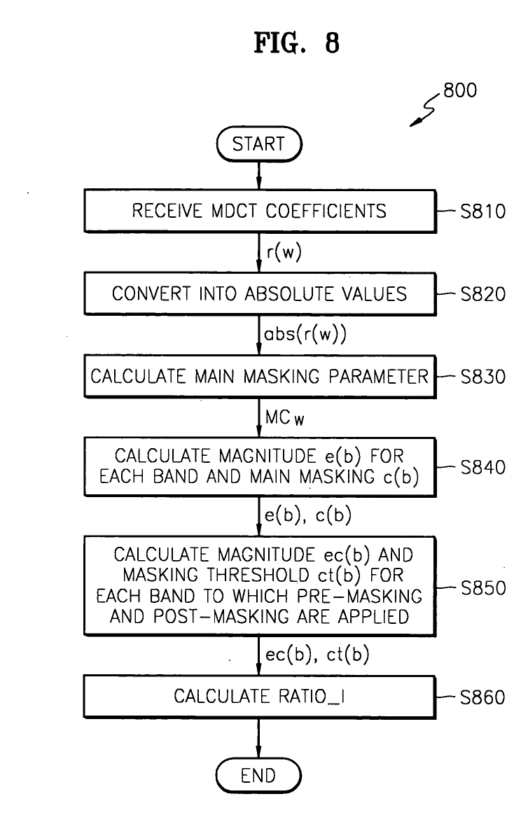

FIG. 8 is a detailed flowchart of MDCT and a parameter-based psychoacoustic model process shown in FIG. 4.

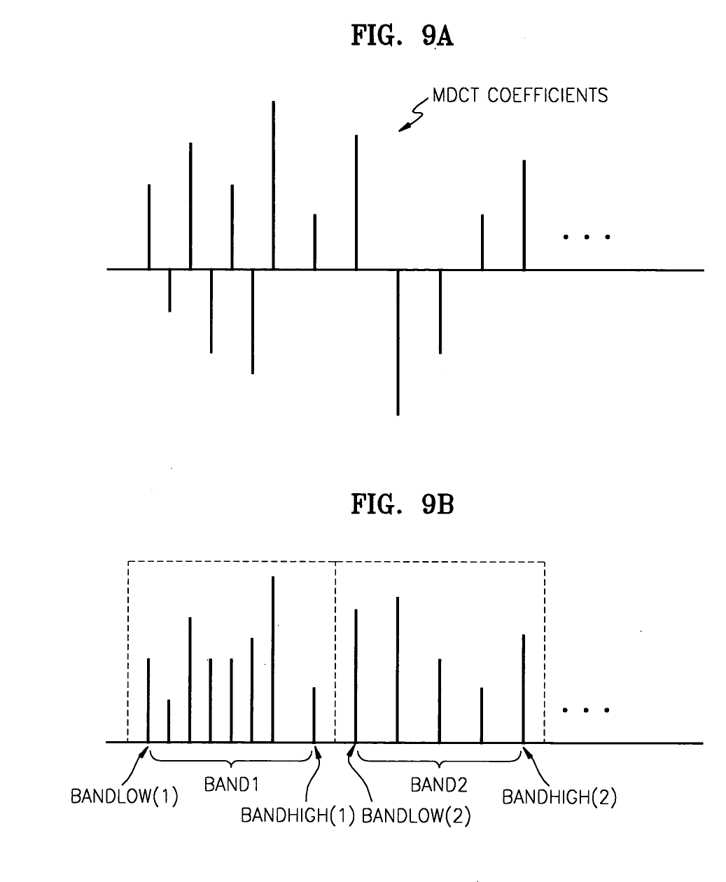

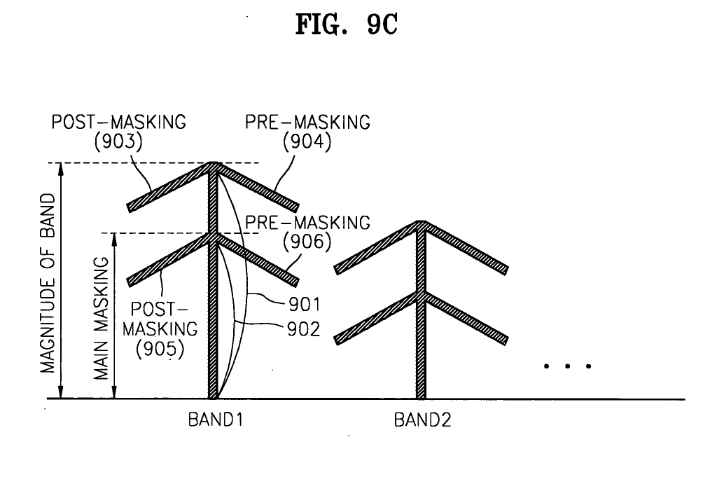

First, MDCT coefficients as shown in FIG. 9A are received as input signals in step S810, and converted into absolute values in step S820. The MDCT coefficients converted into absolute values are shown in FIG. 9B.

Next, by using the MDCT coefficients converted into absolute values, main masking coefficients are calculated in step S830. The main masking coefficient is a value that is a reference value for calculating a masking threshold.

Next, by using the MDCT coefficients converted into absolute values and the main masking coefficient, magnitude e(b) and main masking c(b) of each band is calculated in step S840.

The magnitude e(b) of a band is the sum of MDCT coefficients converted into absolute values belonging to each band, and can be understood as a value indicating the magnitude of the original signal. For example, as shown in FIG. 9B, e(b) for band 1 is a value obtained by simply adding all MDCT coefficients converted into absolute values in band 1, that is, from bandlow(1) to bandhigh(1). Main masking c(b) is a value generated by weighting (that is, multiplying) a main masking coefficient to a MDCT coefficient converted into an absolute value belonging to each band, and can be understood as a value indicating the magnitude of main masking.

For example, in FIG. 9C, reference number 901 indicates band magnitude e(b) of band 1, while 902 indicates main masking c(b).

Next, magnitude ec(b) and main masking ct(b) of each band, for which pre-masking and post-masking are applied to the magnitude e(b) and main masking c(b) of each band, are calculated in step S850.

Unlike the prior art using the spreading function, the present invention uses a pre-masking parameter and a post-masking parameter for computation. A pre-masking parameter is a representative value for forward masking and a post-masking parameter is a representative value for backward masking. For example, in FIG. 9C, post-masking of band magnitude e(b) is shown as indicated by 903, pre-masking is shown as indicated by 904, and post-masking of main masking c(b) is shown as indicated by 905, and pre-masking is shown as indicated by 906.

Pre-masking or post-masking is a concept considering even both side parts of a signal expressed by one value, and ec(b) is a value expressed by post-masking 903+e(b) 901+pre-masking 904, and ct(b) is a value expressed by post-masking 905+c(b) 902+pre-masking 906.

Next, ratio_l is calculated by calculating the calculated ec(b) and ct(b) in step S860. The ratio_l is the ratio of the ec(b) to ct(b).

Though the process shown in FIG. 4 is expressed as a flowchart from the methodological viewpoint, each step shown in the flowchart can be implemented by an apparatus. Accordingly, the encoding process shown in FIG. 4 can also be implemented as an encoding apparatus. Therefore, the structure of the encoding apparatus is not shown separately, and each step shown in FIG. 4 can be regarded as each element of the encoding apparatus.

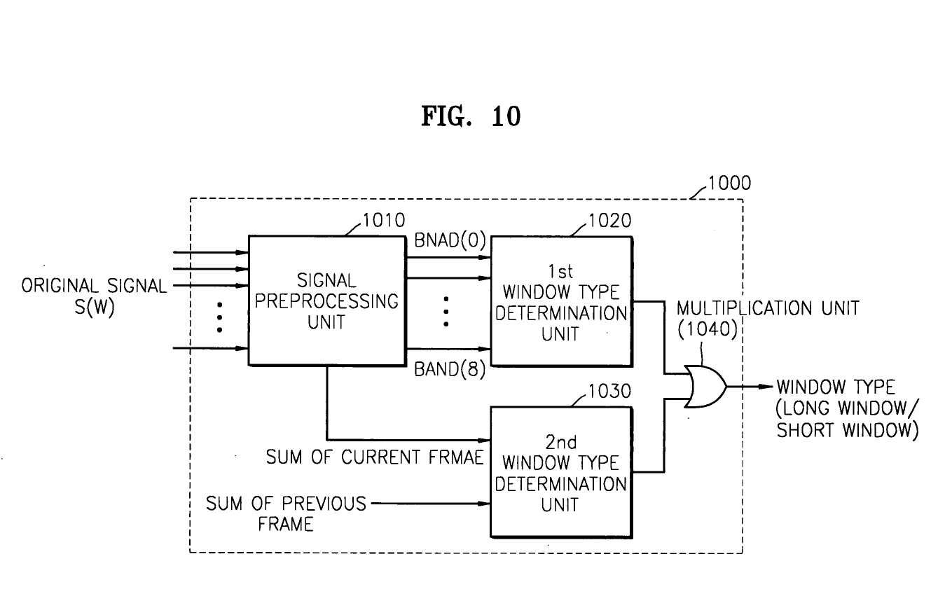

FIG. 10 is a block diagram showing a detailed structure of a window type determination unit performing window type determination shown in FIG. 6.

The window type determination unit 1000 comprises a signal preprocessing unit 1010 which preprocesses the received original signal, a first window type determination unit 1020 which performs window type determination 1 using the result output from the signal preprocessing unit 1010, a second window type determination unit 1030 which performs window type determination 2 using the result output from the signal preprocessing unit 1010, and a multiplication unit 1040 which multiplies the output of the first window type determination unit 1020 by the output of the second window type determination unit 1030, and outputs the result.

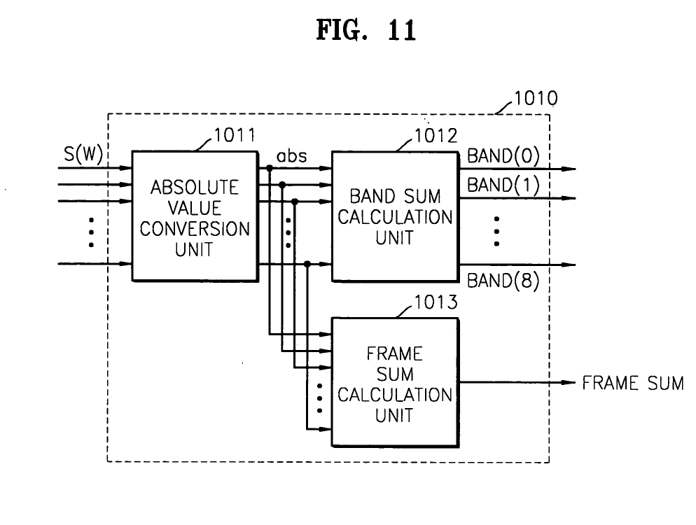

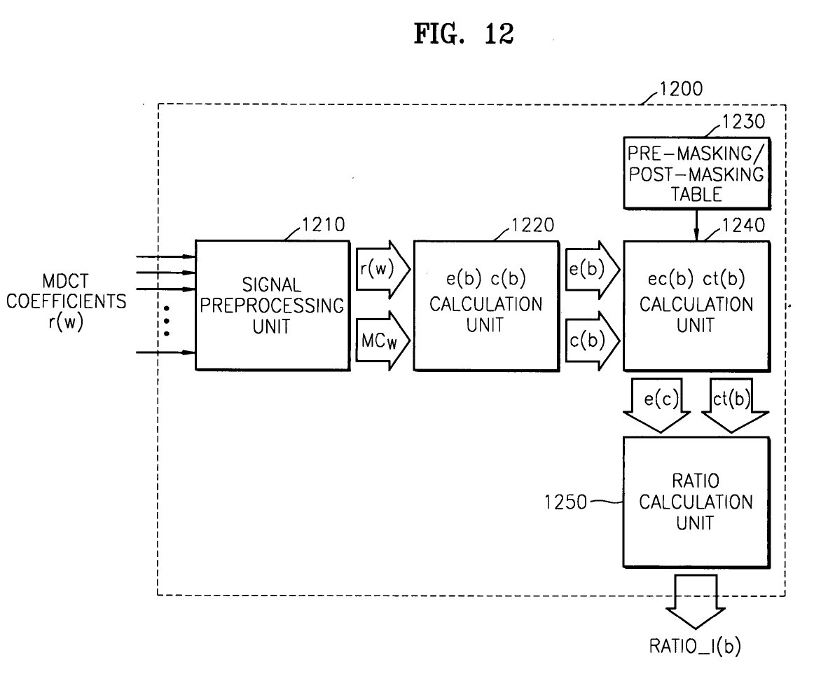

A detailed structure of the signal preprocessing unit 1010 is shown in FIG. 11.

The signal preprocessing unit 1010 comprises an absolute value conversion unit 1011, a band sum calculation unit 1012, and a frame sum calculation unit 1013.

The absolute value conversion unit 101 receives original signal S(w) of one frame comprising 576 samples, converts the samples into absolute values, and outputs converted absolute value signals abs(S(w)) to the band sum calculation unit 1012 and the frame sum calculation unit 1013.

The band sum calculation unit 1012 receives the absolute value signal, divides the signal comprising 576 samples into 9 bands, calculates the sum of the absolute value signal belonging to each band, including band(0), . . . , band(8), and outputs to the first window type determination unit 1020.

The frame sum calculation unit 1013 receives the absolute value signal, calculates the frame sum by simply adding the signal comprising 576 samples, and outputs to the second window type determination unit 1030.

By using thus received band sum signals, the first window type determination unit 1020 performs window type determination 1, and outputs the determined window type signal to the multiplication unit 1040.

Window type determination 1 is to determine what degree of an energy difference is between signals in a frame. If there is a signal difference between bands that is large, the type is determined as a short window type, and if there is not a signal difference between bands that is large, the type is determined as a long window type.

That is, the window type is determined according to the following determination. Since 9 bands are in one frame, determination is performed for each band, and if there is any one band satisfying the following condition, the frame to which the band belongs, that is, the current frame, is determined as a short window type.

if (before_band > current_band*factor)

window_type = short
or
if (current_band > before_band*factor)

window_type = short

By using the received frame sum signal, the second window type determination unit 1030 performs window type determination 2 and outputs the determined window type signal to the multiplication unit 1040.

Window type determination 2 determines what degree of an energy difference is between signals of different frames. If the energy difference between a previous frame signal sum and a current frame signal sum is greater than a predetermined value, the type is determined as a long window type, and if the energy difference is not greater than the predetermined value, the type is determined as a short window type. This determines a window type, secondly.

That is, the window type is determined by the following condition.

if (before_tot_abs > current_tot_abs*factor(0.5))

window_type = long

The multiplication unit 1040 comprises an AND gate which receives the output signals of the first window type determination unit 1020 and the second window type determination unit 1030, and only when both signals are 1, outputs 1. That is, the multiplication unit 1040 can be implemented such that only when both the window type output from the first window type determination unit 1020 and the window type output from the second window type determination unit 1030 are a short window type, the multiplication unit 1040 outputs a short window type as the final window type, or else, outputs a long window type.

By implementing the unit as described above, a case when the energy difference between signals of different frames is not large though the energy difference between signals in one frame is large can be regarded as a case where the entire energy difference is not large. Accordingly, window type determination can be performed more precisely by first considering the energy difference between signals in a frame and then secondly considering the energy difference between signals of different frames.

FIG. 12 is a diagram showing a detailed structure of the psychoacoustic model performing unit 1200 which performs MDCT and a parameter-based psychoacoustic model process shown in FIG. 8. A case when the type is determined as a long window type will first be explained.

The psychoacoustic model performing unit 1200 comprises a signal preprocessing unit 1210 which receives and preprocesses MDCT coefficients and outputs the preprocessed signal result to an e(b) and c(b) calculation unit 1220, the e(b) and c(b) calculation unit 1220 which calculates energy e(b) and main masking c(b) of each band, a pre-masking/post-masking table 1230 which stores pre-masking and post-masking parameters, an ec(b) and ct(b) calculation unit 1240 which calculates the magnitude of band ec(b) and main masking ct(b) by considering pre-masking and post-masking parameters stored in the pre-masking/post-masking table 1230 for the magnitude of band and main masking of each band calculated by the e(b) and c(b) calculation unit 1220, and a ratio calculation unit 1250 which calculates a ratio by using the calculated ec(b) and ct(b) values.

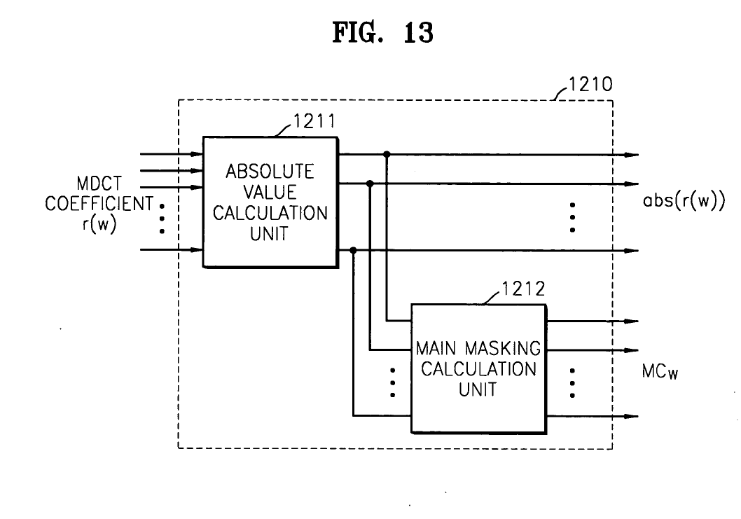

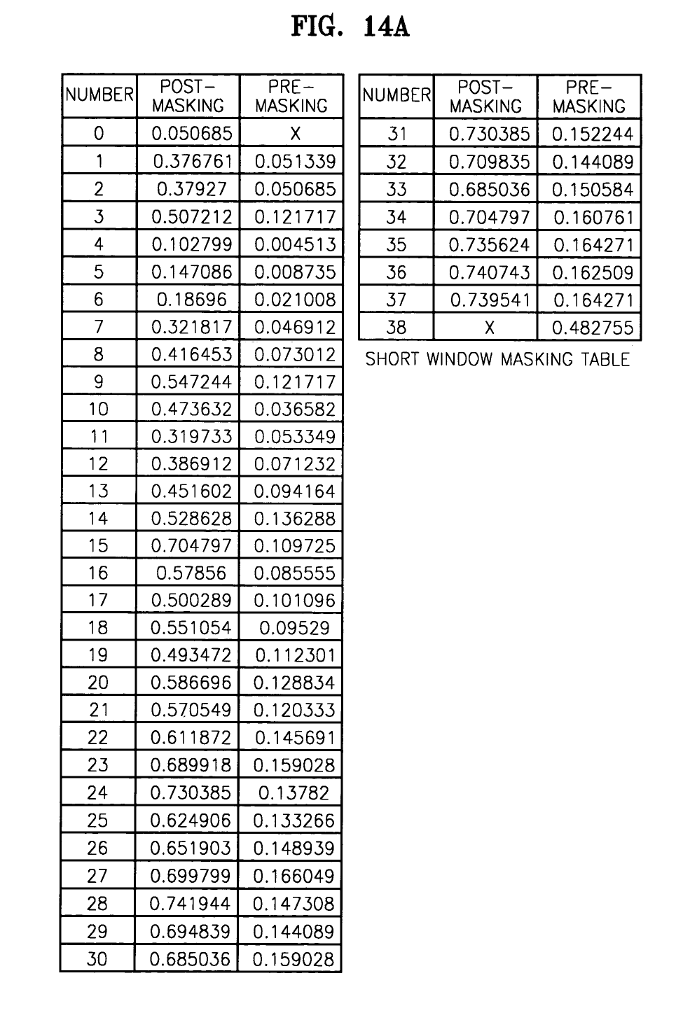

The entire structure of the signal preprocessing unit 1210 is shown in FIG. 13.

The signal preprocessing unit 1210 comprises an absolute value conversion unit 1211 and a main masking calculation unit 1212.

The absolute value conversion unit 1211 receives MDCT coefficient r(w) and converts into an absolute value according to the following equation 9:

r(w)=abs(r(w)) (9)

Then, the signal value converted into an absolute value is output to the e(b) and c(b) calculation unit 1220 and the main masking calculation unit 1212.

The main masking calculation unit 1212 receives the MDCT coefficient converted into an absolute value output from the absolute value conversion unit 1211, and calculates main masking values according to the following equation 10 for samples 0 through 205:

$$M {C}_{w} = \frac{abs ( r ( w ) - abs ( 2 r ( w - 1 ) - ( r ( w - 2 ) )}{abs ( r ( w ) + abs ( 2 r ( w - 1 ) - ( r ( w - 2 ) )} \qquad ( 10 )$$

For samples 207 through 512, main masking values are set to, for example, 0.4, and for samples from 513 through 575, main masking values are not calculated. This is because even though this main masking value is used, the performance is not particularly affected because of the characteristic that signals meaningful in a frame are concentrated on the front part of the frame, and the number of effective signals decreases as a distance from the front part increases.

The main masking calculation unit 1212 outputs thus calculated main masking values to the e(b) and c(b) calculation unit 1220.

The e(b) and c(b) calculation unit 1220 receives MDCT coefficient r(w) converted into an absolute value, and main masking MCw output by the signal preprocessing unit 1210, calculates energy e(b) and main masking c(b) of each band according to the following equation 11, and outputs the calculated result to the ec(b) and ct(b) calculation unit 1240:

$$e ( b ) = {\sum }_{bandlow}^{bandhigh} r ( w ) , c ( b ) = {\sum }_{bandlow}^{bandhigh} r ( w ) \times M {C}_{w} \qquad ( 11 )$$

It is shown that energy e(b) of a band is a simple sum of MDCT coefficients converted into absolute values belonging to the band, and main masking c(b) is the sum of values obtained by multiplying MDCT coefficients converted into absolute values belonging to each band by the received main masking MCw. Here, the magnitude of each band is variable and a band interval for determining the values of bandlow and bandhigh uses a table value disclosed in a standard document. In fact, since effective information is contained in the front part of a signal interval, the length of a band in the front part of a signal interval is shortened and a signal value is precisely analyzed and the length of a band in the back part of a signal interval is lengthened and the amount of computation is made to be reduced.

The ec(b) and ct(b) calculation unit 1240 calculates magnitude ec(b) and main masking ct(b) of a band, which consider the magnitude and main masking of each band output from the e(b) and c(b) calculation unit 1220, and pre-masking and post-masking parameters stored in the pre-masking/post-masking table 1230, according to the following equations 12 and 13, and outputs the calculated result to the ratio calculation unit 1250:

ec(b)=e(b−1)*post_masking+e(b)+e(b+1)*pre_masking (12)

ct(b)=c(b−1)*post_masking+c(b)+c(b+1)*pre_masking (13)

Magnitude ec(b) considering parameters is a value obtained by adding a value obtained by multiplying the magnitude of a previous band by a post-masking value, the magnitude of a current band, and a value obtained by multiplying the magnitude of a next band by a pre-masking value.

Main masking ct(b) considering parameters is a value obtained by adding a value obtained by multiplying a previous main masking value by a post-masking value, the magnitude of a current main masking value, and a value obtained by multiplying a next main masking value by a pre-masking value.

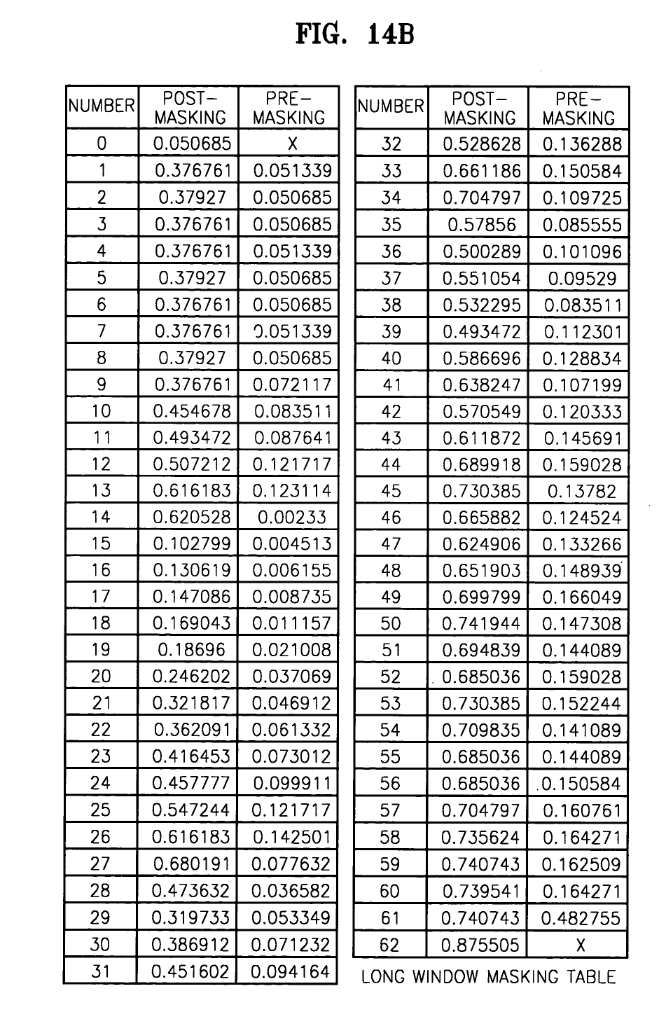

Here, the post-masking value and pre-masking value are transmitted from the pre-masking/post-masking table 1230 shown in FIG. 12, and values stored in the pre-masking/post-masking table are shown in FIGS. 14A and 14B.

The table applied to a long window type is shown in FIG. 14B. For example, it is shown that the post-masking value for band 1 is 0.376761 and the pre-masking value for band 1 is 0.51339.

The ratio calculation unit 1250 receives ec(b) and ct(b) output from the ec(b) and ct(b) calculation unit 1240, and calculates a ratio according to the following equation 14:

$$ratio\_l ( b ) = \frac{c t ( b )}{e c ( b )} \qquad ( 14 )$$

Calculation for a short window type is the same as that for a long window type, except that each band is divided into sub-bands and calculation is performed in units of sub-bands.

A case when the type is determined as a short window type will now be explained, focusing on those parts that are different from the long window type.

The absolute value conversion unit 1211 receives MDCT coefficient r(w) and converts into an absolute value according to the following equation 15:

r_{—}s(sub_band)(w)=abs(r(sub_band)×3+i)) (15)

Then, the signal value converted into an absolute value is output to the e(b) and c(b) calculation unit 1220 and the main masking calculation unit 1212.

The main masking calculation unit 1212 receives the MDCT coefficient converted into an absolute value output from the absolute value conversion unit 1211, and calculates main masking parameters for samples 0 through 55 according to the following equation 16:

$$MC\_Sw = \frac{\begin{matrix}abs ( r\_s ( sub\_band ) ( w ) - abs ( 2 r\_s ( sub\_band ) ( w - 1 ) - \\ ( r\_s ( sub\_band ) ( w - 2 ) )\end{matrix}}{\begin{matrix}abs ( r\_s ( sub\_band ) ( w ) + abs ( 2 r\_s ( sub\_band ) ( w - 1 ) - \\ ( r\_s ( sub\_band ) ( w - 2 ) )\end{matrix}} \qquad ( 16 )$$

Then, for samples 56 through 128, the main masking value is set to, for example, 0.4, and main masking values for samples 129 through 575 are not calculated. This is because even though this main masking value is used, the performance is not particularly affected because of the characteristic that signals meaningful in a frame are concentrated on the front part of the frame, and the number of effective signals decreases as a distance from the front part increases.

The main masking calculation unit 1212 outputs thus calculated main masking values to the e(b) and c(b) calculation unit 1220.

The e(b) and c(b) calculation unit 1220 receives MDCT coefficient r(w) converted into an absolute value, and main masking MCw output by the signal preprocessing unit 1210, calculates energy e(b) and main masking c(b) of each band according to the following equation 17, and outputs the calculated result to the ec(b) and ct(b) calculation unit 1240:

$$\begin{matrix}e ( sub\_band ) ( b ) = {\sum }_{bandlow}^{bandhigh} r\_s ( sub\_band ) ( w ) , c ( sub\_band ) ( b ) \\ = {\sum }_{bandlow}^{bandhigh} \{ r\_s ( sub\_band ) ( w ) \times MC\_Sw \}\end{matrix} \qquad ( 17 )$$

It is shown that energy e(b) of a band is a simple sum of MDCT coefficients converted into absolute values belonging to the band, and main masking c(b) is the sum of values obtained by multiplying MDCT coefficients converted into absolute values belonging to each band by the received main masking MCw. Here, the magnitude of each band is variable and a band interval for determining the values of bandlow and bandhigh uses a table value disclosed in a standard document. In fact, since effective information is contained in the front part of a signal interval, the length of a band in the front part of a signal interval is shortened and a signal value is precisely analyzed and the length of a band in the back part of a signal interval is lengthened and the amount of computation is made to be reduced.

The ec(b) and ct(b) calculation unit 1240 calculates magnitude ec(b) and main masking ct(b) of a band, which consider the magnitude and main masking of each band output from the e(b) and c(b) calculation unit 1220, and pre-masking and post-masking parameters stored in the pre-masking/post-masking table 1230, according to the following equations 18 and 19, and outputs the calculated result to the ratio calculation unit 1250:

ec(sub_band)(b)=e(sub_band)(b−1)*post_masking+e(sub_band)(b)+e(sub_band)(b+1)*pre_masking (18)

ct(sub_band)(b)=c(sub_band)(b−1)*post_masking+c(sub_band)(b)+c(sub_band)(b+1)*pre_masking (19)

Magnitude ec(b) considering parameters is a value obtained by adding a value obtained by multiplying the magnitude of a previous band by a post-masking value, the magnitude of a current band, and a value obtained by multiplying the magnitude of a next band by a pre-masking value.

Main masking ct(b) considering parameters is a value obtained by adding a value obtained by multiplying a previous main masking value by a post-masking value, the magnitude of a current main masking value, and a value obtained by multiplying a next main masking value by a pre-masking value.

Here, the post-masking value and pre-masking value are transmitted from the pre-masking/post-masking table 1230 shown in FIG. 12, and values stored in the pre-masking/post-masking table are shown in FIGS. 14A and 14B.

The table applied to a short window type is shown in FIG. 14A. For example, it is shown that the post-masking value for band 1 is 0.376761 and the pre-masking value for band 1 is 0.51339.

The ratio calculation unit 1250 receives ec(b) and ct(b) output from the ec(b) and ct(b) calculation unit 1240, and calculates a ratio according to the following equation 20:

$$ratio\_s ( sub\_band ) ( b ) = \frac{c t ( sub\_band ) ( b )}{e c ( sub\_band ) ( b )} \qquad ( 20 )$$

Accordingly, the psychoacoustic model of the present invention provides similar performance with reduced the complexity as compared to the conventional psychoacoustic model. That is, the calculation based on FFT in the conventional psychoacoustic model is replaced by MDCT-based calculation such that unnecessary calculation is removed. Also, by replacing calculations for the spreading function by two parameters, post-masking and pre-masking parameters, the amount of computation can be reduced. That is, an experiment employing a PCM file (13 seconds) as a test file and bladencoder 0.92 version as an MP3 encoder was performed, and in the experiment, the MP3 algorithm based on the FFT used in the prior art MP3 took 20 seconds, while the algorithm according to the present invention took 12 seconds. Therefore, the method according to present invention reduces the amount of computation by 40% over the conventional method.

In addition, the performance of the present invention showed little difference from that of the conventional method, performing the same functions as those of the prior art.

What is claimed is

1. A moving picture experts group (MPEG) audio encoding method comprising:
(a) performing modified discrete cosine transform (MDCT) for an input audio signal in a time domain to generate MDCT coefficients;
(b), performing a psychoacoustic model based on the MDCT coefficients; and
(c) performing quantization based on a result of the psychoacoustic model, and packing a bitstream.

2. The method of claim 1, wherein the step (b) is performed based on a pre-masking parameter that is a representative value for forward masking, and a post-masking parameter that is a representative value for backward masking.

3. A moving picture experts group (MPEG) audio encoding method comprising:
(a) determining a window type of the frame for an input audio signal in a time domain based on an energy difference of signals in a frame and an energy difference of signals of different frames;
(b) performing a parameter-based psychoacoustic model, based on a pre-masking parameter that is a representative value for forward masking, and a post-masking parameter that is a representative value for backward masking, for modified discrete cosine transform (MDCT) coefficients that are obtained by performing MDCT for an input audio signal in a time domain; and
(c) performing quantization, and packing a bitstream based on a result of the psychoacoustic model.

4. The method of claim 3, wherein in the step (a), the window type is determined as a short window type or a long window type depending on whether the energy difference of the signals in the frame is greater than a first predetermined threshold and the energy difference of the signals of the different frames is greater than a second predetermined threshold.

5. The method of claim 4, wherein in the step (b), if the determined window type is the long window type, the parameter-based psychoacoustic model is performed based on the pre-masking parameter and the post-masking parameter in units of bands of signals, and if the determined window type is the short window type, the parameter-based psychoacoustic model is performed based on the pre-masking parameter and the post-masking parameter in units of sub-bands in each band of signals.

6. The method of claim 4, wherein the step (b) comprises:
(b1) calculating a magnitude of a band and a masking threshold based on a pre-masking parameter and a post-masking parameter as follows:
magnitude of a band=magnitude of a previous band * post-masking parameter+magnitude of a current band+magnitude of a next band * pre-masking parameter, and
masking threshold=magnitude of main masking of a previous band * post-masking parameter+magnitude of main masking of a current band+magnitude of main masking of a next band * pre-masking parameter; and
(b2) calculating a ratio of the calculated magnitude of the band to the calculated masking threshold.

7. A window type determination method when encoding a moving picture experts group (MPEG) audio, comprising:
(a) receiving an input audio signal comprising a plurality of samples in a time domain, and converting the samples into an absolute values;
(b) dividing the samples converted into the absolute values into a predetermined number of bands forming a frame, and calculating a band sum that is a sum of the absolute values belonging to a band, for each band;
(c) performing a first window type determination based on a difference between the band sums of adjacent bands;
(d) calculating a current frame sum that is a sum of the absolute values in the frame, and performing second window type determination based on a difference between a previous frame sum and the current frame sum; and
(e) determining a window type by combining a result of the first window type determination and a result of performing the second window type determination.

8. The method of claim 7, wherein in the step (c) the window type is determined as a short window type or a long window type depending on whether a current band sum in the frame is greater than a predetermined multiple of a previous band sum, or the previous band sum is greater than a predetermined multiple of the current band sum.

9. The method of claim 8, wherein in the step (d) the window type is determined as the short window type or the long window type depending on whether the previous frame sum is greater than a predetermined multiple of the current frame sum.

10. The method of claim 9, wherein in the step (e), if both the determinations of steps (c) and (d) are the short window type, the window type is finally determined as the short window type, and if both the determinations of steps (c) and (d) are not the short window type, the window type is determined as the long window type.

11. A parameter-based psychoacoustic modeling method when encoding a moving picture experts group (MPEG) audio, comprising:
(a) receiving modified discrete cosine transform (MDCT) coefficients obtained by performing MDCT for an input audio signal having a plurality of bands, and converting the MDCT coefficients into absolute values;
(b) calculating a main masking parameter based on the absolute values;
(c) calculating a first magnitude of each band by using corresponding absolute values of each band, and calculating a magnitude of main masking of each band based on the corresponding absolute values of each band and the main masking parameter;
(d) calculating a second magnitude of each band by applying a pre-masking parameter that is a representative value for forward masking and a post-masking parameter that is a representative value for backward masking, to the first magnitude of each band, and calculating a main masking threshold by applying the pre-masking parameter and post-masking parameter to the main masking magnitude; and
(e) calculating a ratio of the second magnitude of each band to the main masking threshold of each band.

12. The method of claim 11, wherein in the step (b) the main masking parameter MC_{w} is calculated based on the absolute values r(w) according to the following equation:
$$M {C}_{w} = \frac{abs ( r ( w ) - abs ( 2 r ( w - 1 ) - ( r ( w - 2 ) )}{abs ( r ( w ) + abs ( 2 r ( w - 1 ) - ( r ( w - 2 ) )}$$

13. The method of claim 12, wherein in the step (c), the magnitude e(b) of each band b and the magnitude of main masking c(b) of each band b are calculated according to the following equations:
$$e ( b ) = {\sum }_{bandlow}^{bandhigh} r ( w ) , c ( b ) = {\sum }_{bandlow}^{bandhigh} r ( w ) \times M {C}_{w}$$

14. The method of claim 13, wherein in the step (d) the first magnitude ec(b) of each band b and the main masking threshold ct(b) of each band b are calculated according to the following equations:
ec(b)=e(b−1)*post_masking+e(b)+e(b+1)*pre_masking
ct(b)=c(b−1)*post_masking+c(b)+c(b+1)*pre_masking

15. A moving picture experts group (MPEG) audio encoding apparatus comprising:
a modified discrete cosine transform (MDCT) unit which performs MDCT on an input audio signal in a time domain to generate MDCT coefficients;
a psychoacoustic model performing unit which performs a psychoacoustic model based on the MDCT coefficients;
a quantization unit which performs quantization based on a result the psychoacoustic model; and
a packing unit which packs a quantization result of the quantization unit into a bitstream.

16. The apparatus of claim 15, wherein the psychoacoustic model performing unit performs the psychoacoustic model based on a pre-masking parameter that is a representative value for forward masking, and a post-masking parameter that is a representative value for backward masking.

17. A moving picture experts group (MPEG) audio encoding apparatus comprising:
a window type determination unit which determines a window type of a frame for an input audio signal in a time domain, base on an energy difference of signals in the frame and an energy difference of signals of different frames;
a psychoacoustic model performing unit which based on a pre-masking parameter that is a representative value for forward masking, and a post-masking parameter that is a representative value for backward masking, performs a parameter-based psychoacoustic model for modified discrete cosine transform (MDCT) coefficients that are obtained by performing MDCT for the input audio signal in the time domain;
a quantization unit which performs quantization based on a result of performing the psychoacoustic model; and
a packing unit which packs a quantization result of the quantization unit into a bitstream.

18. The apparatus of claim 17, wherein the window type is determined as a short window type or a long window type depending on whether the energy difference of the signals in the frame is greater than a first predetermined threshold and the energy difference of the signals of the different frames is greater than a second predetermined threshold.

19. The apparatus of claim 18, wherein if the determined window type is the long window type, the psychoacoustic model performing unit performs the parameter-based psychoacoustic model based on the pre-masking parameter and the post-masking parameter in units of bands of signals, and if the determined window type is the short window type, performs the parameter-based psychoacoustic model considering the pre-masking parameter and post-masking parameter in units of sub-bands in each band of signals.

20. The apparatus of claim 18, wherein the psychoacoustic model performing unit calculates a magnitude of a band and a masking threshold based on the pre-masking parameter and the post-masking parameter according to the following equations:
magnitude of a band=magnitude of a previous band * post-masking parameter+magnitude of a current band+magnitude of a next band * pre-masking parameter, and
masking threshold=magnitude of main masking of a previous band * post-masking parameter+magnitude of main masking of a current band+magnitude of main masking of a next band * pre-masking parameter; and
calculates a ratio of the magnitude of the band to the masking threshold.

21. A window type determination apparatus when encoding moving picture experts group (MPEG) audio, comprising:
an absolute value conversion unit which receives an input audio signal comprising a plurality of samples in a time domain, and converts the samples into absolute values;
a band sum calculation unit which divides the samples converted into the absolute values into a predetermined number of bands forming a frame, and calculates a band sum that is a sum of the absolute values belonging to a band, for each band;
a first window type determination unit which performs a first window type determination based on a difference between the band sums of adjacent bands;
a second window type determination unit which calculates a frame sum that is a sum of all of the absolute values of the frame, and performs a second window type determination based on a difference between a previous frame sum and a current frame sum; and
a multiplication unit which determines a window type by combining a result of performing the first window type determination and a result of performing the second window type determination.

22. The apparatus of claim 21, wherein the first window type determination unit determines the window type as the short window type or the long window type depending on whether a current band sum in the frame is greater than a predetermined multiple of the previous band sum, or the previous band sum is greater than a predetermined multiple of the current band sum.

23. The apparatus of claim 22, wherein the second window type determination unit determines the window type as the short window type or the long window type depending on whether the previous frame sum between frames is greater than a predetermined multiple of the current frame sum.

24. The apparatus of claim 23, wherein if both the determinations of the first window type determination unit and second window type determination unit are the short window type, the multiplication unit determines the type as the short window type, and if both the determinations of the first window type determination unit and second window type determination unit are not the short window type, the multiplication unit determines the type as the long window type.

25. A psychoacoustic modeling apparatus in a moving picture experts group (MPEG) audio encoding system, the apparatus comprising:
an absolute value conversion unit which receives modified discrete cosine transform (MDCT)coefficients obtained by performing MDCT for an input audio signal having a plurality of bands, and converts the MDCT coefficients into absolute values;
a main masking calculation unit which calculates a main masking parameter based on the absolute values;
a first calculation unit which calculates a first magnitude of each band based on corresponding absolute values of each band, and calculates a magnitude of main masking of each band based on the corresponding absolute values of each band and the main masking parameter;
a second calculation unit which calculates a second magnitude of a band by applying a pre-masking parameter that is a representative value for forward masking and a post-masking parameter that is a representative value for backward masking, to the first magnitude of each band, and calculates a main masking threshold by applying the pre-masking parameter and post-masking parameter to the magnitude of main masking; and
a ratio calculation unit which calculates a ratio of the second magnitude of each band to the main masking threshold of each band.

26. The apparatus of claim 25, wherein the main masking parameter calculation unit calculates the main masking parameter MC_{w} based on the absolute values r(w) according to the following equation:
$$M {C}_{w} = \frac{abs ( r ( w ) - abs ( 2 r ( w - 1 ) - ( r ( w - 2 ) )}{abs ( r ( w ) + abs ( 2 r ( w - 1 ) - ( r ( w - 2 ) )}$$

27. The apparatus of claim 26, wherein the first calculation unit calculates the first magnitude e(b) of each band b and the magnitude of main masking c(b) of each band b according to the following equations:
$$e ( b ) = {\sum }_{bandlow}^{bandhigh} r ( w ) , c ( b ) = {\sum }_{bandlow}^{bandhigh} r ( w ) \times M {C}_{w}$$

28. The apparatus of claim 27, wherein the second calculation unit calculates the second magnitude ec(b) of each band b and the main masking threshold ct(b) of each band b according to the following equations:
ec(b)=e(b−1)*post_masking+e(b)+e(b+1)*pre_masking
ct(b)=c(b−1)*post_masking+c(b)+c(b+1)*pre_masking
